(19) United States
(12) Patent Application Publication
(10) Pub. No.: US 2024/0300488 A1
(43) Pub. Date: Sep. 12, 2024

(54) VEHICLE UNDERWATER DETECTION SYSTEM

(71) Applicant: FCA US LLC, Auburn Hills, MI (US)

(72) Inventors: James J. Daley, Jackson, MI (US); Basil Khaja, Waterford, MI (US)

(21) Appl. No.: 18/181,864

(22) Filed: Mar. 10, 2023

(51) Int. Cl. B60W 30/095; B60W 10/184; B60W 10/20; B60W 30/09; B60W 30/14; B60W 50/14

(52) U.S. Cl. CPC B60W 30/0956; B60W 10/184; B60W 10/20; B60W 30/09; B60W 30/143; B60W 50/14; B60W 2050/146; B60W 2520/00; B60W 2555/20

(57) ABSTRACT

In at least some implementations, an underwater detection system for a land vehicle includes a submersion sensor, and underwater sensor and a controller. The submersion sensor is adapted to determine when at least part of a vehicle is submerged in water. The underwater sensor is capable of detecting an underwater environmental parameter, and the controller is coupled to both the submersion sensor and the underwater sensor.

### FIELD

The present disclosure relates to an underwater detection system for a vehicle.

### BACKGROUND

Vehicles may be driven into water, and water greater than a threshold depth and/or obstacles in the water having parameters beyond one or more thresholds may be impossible to detect from within the vehicle. Thus, navigating a vehicle through water can be challenging, and can potentially damage the vehicle.

### SUMMARY

In at least some implementations, an underwater detection system for a land vehicle includes a submersion sensor, an underwater sensor and a controller. The submersion sensor is adapted to determine when at least part of a vehicle is submerged in water. The underwater sensor is capable of detecting an underwater environmental parameter, and the controller is coupled to both the submersion sensor and the underwater sensor.

In at least some implementations, a display is provided to show a vehicle occupant: a) a determined vehicle path of travel, b) data or graphics derived from data obtained from the submersion sensor or the underwater sensor, c) or both a and b.

In at least some implementations a fluid flow sensor, a vehicle speed sensor, or a vehicle inclination sensor are included, to provide further information to a vehicle controller or control system or a driver of the vehicle.

In at least some implementations the underwater sensor provides output to the controller as a function of the location and size of objects and water depth surrounding the vehicle. In at least some implementations a display is provided whereby feedback including the location and size of objects and water depth surrounding the vehicle is displayed to a vehicle occupant. In at least some implementations. In at least some implementations, feedback is provided to the controller and the controller is adapted to communicate with a driving control system that uses the feedback to navigate the vehicle.

In at least some implementations a global positioning system is coupled to the controller, to provide information about the location of the vehicle and areas around the vehicle, as well as along a path of travel of the vehicle.

In at least some implementations a vehicle drive control system is capable of changing vehicle drive controls, and is communicated with the controller.

In at least some implementations, a method of navigating a land vehicle through water, comprises the steps of determining that at least part of the vehicle is submerged in water, receiving information from an underwater sensor, and either or both a) controlling the vehicle as a function of the information, or b) providing feedback as a function of the information to a driver of the vehicle.

In at least some implementations, one or more of a vehicle speed and a vehicle direction is controlled as a function of the information from the underwater sensor.

In at least some implementations, feedback is provided as a function of the information to a driver of the vehicle and is accomplished by providing a visual display that is viewable by the driver.

In at least some implementations, the information includes one or more of a depth of the water at one or more locations, a velocity of the water and a direction of flow of the water. In at least some implementations, the vehicle has a current path of travel, and wherein the depth of water in the current path of travel is compared to the depth of water outside the current path of travel. In at least some implementations, the vehicle is controlled to change the path of travel when the depth of water outside the current path of travel is less than the depth of water in the current path of travel.

In at least some implementations, controlling the vehicle as a function of the information includes one or more of controlling acceleration, braking, and steering or direction of the vehicle.

In at least some implementations, the information is used to detect that an obstacle is within a path of travel of the vehicle. In at least some implementations, controlling the vehicle as a function of the information includes altering one or both of vehicle speed and vehicle direction as a function of the detection of the obstacle. In at least some implementations, the information is used to detect an obstacle outside of a path of travel of the vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a side view of a land vehicle that is partially submerged in water, and includes a submersion sensor and an underwater sensor;

FIG. 2 is a side view of part of the land vehicle that is partially submerged in water, and shows an underwater obstacle near the land vehicle;

FIG. 3 is a side view of part of the land vehicle that is partially submerged in water and shows a varying water depth near the land vehicle;

FIG. 4 is a depiction of a land vehicle's current path, an obstacle, and a new vehicle path;

FIG. 5 is a depiction of a land vehicle's current path, multiple obstacles, and a new vehicle path;

FIG. 6 is a depiction of a land vehicle's current path, varying water depth, and a new vehicle path;

FIG. 7 is a flow chart of a method of navigating a land vehicle through water and controlling the land vehicle and/or providing vehicle occupant(s) with information;

FIG. 8 is a flow chart of a system of sensors providing data to a controller that outputs to vehicle occupant feedback devices and/or vehicle drive controls;

FIG. 9 is a depiction of an underwater sensor consisting of an emitter, a receiver, and a signal output; and

FIG. 10 is a diagrammatic and sectional view of a submersion sensor.

### DETAILED DESCRIPTION

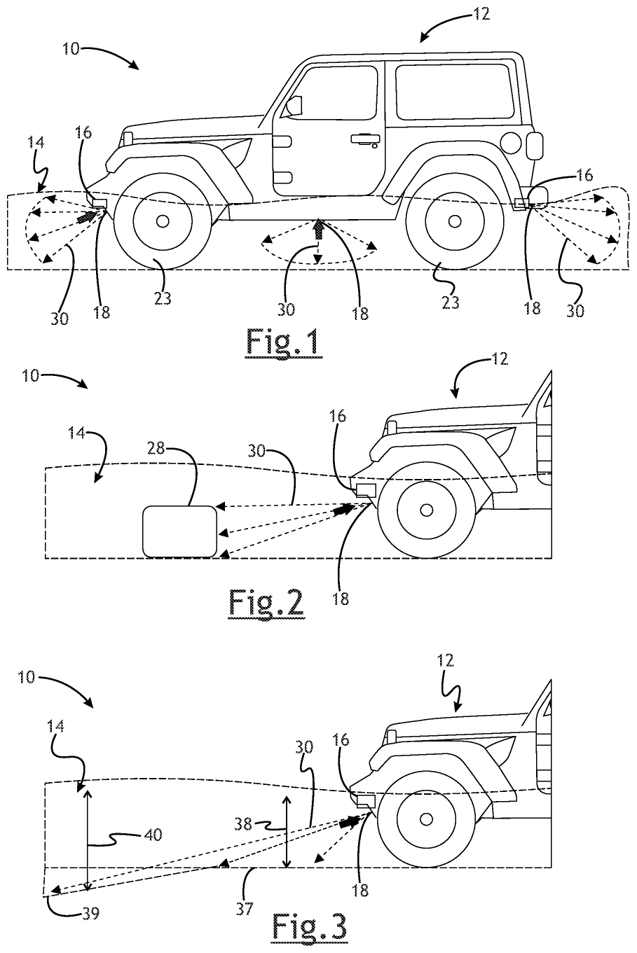

Referring in more detail to the drawings, FIGS. 1-3 show an underwater detection system 10 for a land vehicle 12 that has been driven into and is partially submerged in water 14, such as a body of water like a creek or pond, or a temporary accumulation of water like a large puddle. Unlike obstacles on the land, submerged obstacles 28 (FIGS. 2, 4 and 5) in the water 14 may be difficult or impossible for a driver to see, and the depth of the water 14 ahead of the vehicle 12 may be unknown. Accordingly, to assist in navigating the vehicle 12 out of or through the water 14, the vehicle 12 is equipped with one or more sensors, such as submersion sensors 16 operable to determine when a portion of the vehicle 12 is submerged in water 14, and one or more underwater sensors 18 operable to determine one or more underwater environmental parameters. The underwater environmental parameters may include, for example, water depth and changes in water depth in different areas at and spaced from the vehicle 12, and the location, size and shape of obstacles 28 in the water 14.

The vehicle 12 has multiple wheels 23 that remain in contact with the ground, even when navigating through water. That is, the vehicle does not float and so must go over or around obstacles on the ground within the water, and water depths can be problematic. The vehicle may have body panels, bumpers, structural members and the like that define an exterior of the vehicle 12. One or more submersion sensors 16 are mounted to the vehicle 12 at a predetermined height and are operable to determine when at least part of the vehicle 12 is in water 14 at or greater than a threshold depth. In at least some implementations, the submersion sensors 16 are responsive to being covered by or submerged in water 14, and when that occurs, the submersion sensor 16 provides an output signal to a controller 26 (FIGS. 8 and 9) or control system 27 of the vehicle 12.

By way of one, non-limiting example, the submersion sensor 16 may include, as shown in FIG. 10, an inlet 17 through which water 14 enters and a float 19 that is buoyant in water 14 and acted upon by water 14 that enters the inlet 17. When the float 19 is sufficiently raised by water 14, the float 19 closes a switch 21 and a signal is sent from an output of the submersion sensor 16 to the controller 26. The height of the switch 21 can thus define a threshold level of water, where water 14 below the threshold level does not cause an output from the sensor 16, in this example. In this way, the submersion sensor 16 is responsive to water 14 at or beyond a threshold level or depth. The submersion sensor 16 may be arranged, e.g. with a shield or a water inlet 17 of sufficient size, so that water not indicative of vehicle 12 submersion, like rain or splashed water, does not enter the sensor inlet 17, or exits the sensor inlet 17 without raising the float 19 sufficiently to cause a signal to be emitted from the sensor 16. This can reduce or eliminate erroneous signals from the submersion sensors 16. Of course, other submersion sensors 16 may be used to determine when at least part of a vehicle 12 is submerged in water 14 at or above a threshold level. Such other sensors may include but are not limited to sensors wherein the water 14 itself is detected or changes the state of the switch 21, rather than a float 19.

Traveling through uneven terrain may result in one portion of the vehicle 12 being submerged within water 14 beyond the threshold level while another portion of the vehicle 12 is not. Therefore, multiple submersion sensors 16 may be mounted at various locations on the vehicle 12 to enable detection if different portions of the vehicle 12 are submerged in water 14 at or beyond the threshold level. In such implementations, the particular portion of the vehicle 12 that is submerged can also be determined based upon the location of the submersion sensor(s) 16 providing an output indicating submersion. In at least some implementations, the submersion sensors 16 function to detect submersion of at least part of the vehicle 12 but do not detect underwater environmental parameters like the presence of obstacles 28 or underwater terrain conditions. In at least some implementations, the underwater environmental parameters are determined by the underwater sensors 18 which may be located in the same or different areas of the vehicle 12 as the submersion sensors 16.

The underwater sensor(s) 18 are mounted to the vehicle 12, and arranged to detect one or more underwater environmental parameters when at least part of the vehicle 12 is submerged in water 14. In at least some implementations, as shown in FIG. 9, the underwater sensors 18 include an emitter 20, a receiver 22 and a signal output 24. The emitter 20 emits light or sound waves 30 (FIGS. 1-3) that travel through water 14. When these waves 30 impact an object, such as the ground or an obstacle 28 in the water, at least a portion of the wave 30 is reflected back to the underwater sensor 18 and is detected or received by the receiver 22. In at least some implementations, multiple underwater sensors 18 can be mounted on the vehicle 12 and arranged so that waves 30 are emitted and reflected from different areas around the vehicle 12, and may provide coverage up to 360 degrees around the vehicle 12 to enable detection of underwater environmental parameters around the vehicle 12. Finally, data as a function of the emitted and reflected waves 30 is provided from the signal output 24 of the underwater sensor 18, to a controller 26 that process the data and determines the underwater environmental parameters.

The controller 26 is positioned on or within the vehicle 12 and is coupled to the submersion sensors 16 and the underwater sensors 18 by wired or wireless connections to receive the data from the signal outputs 24 of the sensors 18. The controller 26 processes the data and generates feedback as a function of that data. The feedback or information from the controller 26 may be provided to either or both of vehicle occupant(s) and a vehicle control system 27. Information provided to the occupant(s) permits the occupants (e.g. a driver) to better control the vehicle 12 in view of the information. Information provided to the vehicle control system 27 may permit automated control of one or more vehicle drive functions to permit automated/computer controlled driving of the vehicle 12.

Utilizing data from the underwater sensors 18, the controller 26 can determine the depth of the water 14 at varying distances and locations relative to the vehicle 12, and the size, shape and location of obstacles 28 around the vehicle 12. In at least some implementations, the time differential between when: 1) a wave 30 is emitted; and 2) a reflection is received by the underwater sensors 18, allows the controller 26 to determine the distance the ground or obstacle 28 is from the underwater sensor 18. The amount of the wave 30 reflected and the angle of the wave 30 reflected may be used by the controller 26 to determine the size, shape and location of the ground or obstacle 28 relative to the underwater sensor 18, and hence, the vehicle 12. In this way, the controller 26 can determine various underwater environmental parameters and use that information to help an occupant or a controller 26 determine one or more paths of travel navigable by the vehicle 12.

In at least some implementations, the vehicle 12 may be able to travel through a body of water 14 having underwater environmental parameters of certain limits or thresholds, but it is either not preferred or the vehicle 12 should not travel through an area or portion of a body of water 14 having underwater environmental parameters beyond one or more thresholds. The underwater environmental parameters may relate to, for example, water depth, slope of terrain, and obstacles 28 at least partially under water 14.

The underwater environmental parameters may vary in different vehicles and predetermined thresholds may be set as a function of the maximum water depth through and terrain severity over which the vehicle 12 is approved for travel, as well as combinations of these parameters. In this regard, an area of the body of water 14 having a water depth or terrain slope or combination of depth and slope greater than a threshold represents an area through which the vehicle 12 should not travel.

Similarly, the environmental underwater parameters may include obstacle parameters that may be set as a function of obstacle(s) 28 of a maximum severity over which the vehicle 12 is approved to travel. Representative obstacle parameters include, but are not limited to, width, length, height, shape (e.g a step or a shallow slope over which a vehicle wheel may travel), or spacing relative to nearby obstacles 28. Detection of obstacles 28 in the current path of travel 32 that have one or more parameters beyond a threshold indicates that the vehicle 12 should not travel over that obstacle 28.

In addition to underwater environmental parameters relating to obstacles 28, terrain slope and water depth, other environmental underwater parameters may be useful in determining a navigable path through a body of water 14. To aid in determining one or more paths of travel for the vehicle 12, or to provide additional information to a driver, or both, additional underwater sensors 56 may be used to provide additional information to the controller 26 and/or a driver of the vehicle 12. As shown in FIG. 8, system 54 uses underwater and/or additional sensors 56 that may include, for example, a fluid flow sensor that may help determine the direction and/or speed of fluid flow (e.g. water current), a vehicle speed sensor, a vehicle inclination sensor, and/or a global position system (GPS), a vehicle ride height sensor may provide information regarding the height of at least part of a vehicle relative to ground, in a vehicle where the ride height may be adjusted (e.g. by air suspension adjustment). These sensors may provide inputs to the controller 26, and the controller 26 may use data from the sensors in making certain determinations or otherwise, as set forth in more detail below.

Various underwater environmental parameters may be predetermined and stored in a memory device accessible by the controller 26, and the controller 26 may compare data from the underwater sensors 18, and/or other sensors, against the stored parameters to determine if the vehicle 12 can be driven through a certain area of the body of water 14. If not, a different path should be chosen or the vehicle 12 should be removed from the water 14 (e.g. operated in reverse).

A general system arrangement is shown in FIG. 8, and includes multiple sensors or data sources that provide inputs to the controller 26. The controller 26 in turn provides an output to one or both of the vehicle occupants and to a vehicle control system 27 by which the vehicle drive controls may be commanded to control vehicle 12 travel. In this regard, sensors for different vehicle drive parameters may be communicated with the controller 26 or the vehicle control system 27 to provide feedback of the vehicle's 12 speed, steering angle, inclination and the like, to enable desired vehicle 12 movement along a path of travel.

In use of the system 10, a current vehicle travel path 32 is determined by the controller 26, as a function of various information and leading to a desired waypoint, which may be an endpoint or destination of the desired travel. The current vehicle travel path 32 may be displayed in the vehicle 12, such as on a display screen 36, for use by a driver in navigating the vehicle 12, or the vehicle controller 26 may operate vehicle drive controls (e.g. acceleration, braking, steering) through a vehicle control system 27 to maneuver the vehicle 12 along the current travel path 32. However, if one or more underwater environmental parameters in the current path of travel 32 is beyond a threshold, the controller 26 will determine that a new path of travel 34 needs to be found. In this case, underwater environmental parameters for areas outside the current path of travel 32, as determined by signals from the underwater sensors 18 or from other sensors, systems (e.g. GPS) or data, will be determined to try and find a new path of travel 34 that does not include underwater environmental parameters outside of a threshold.

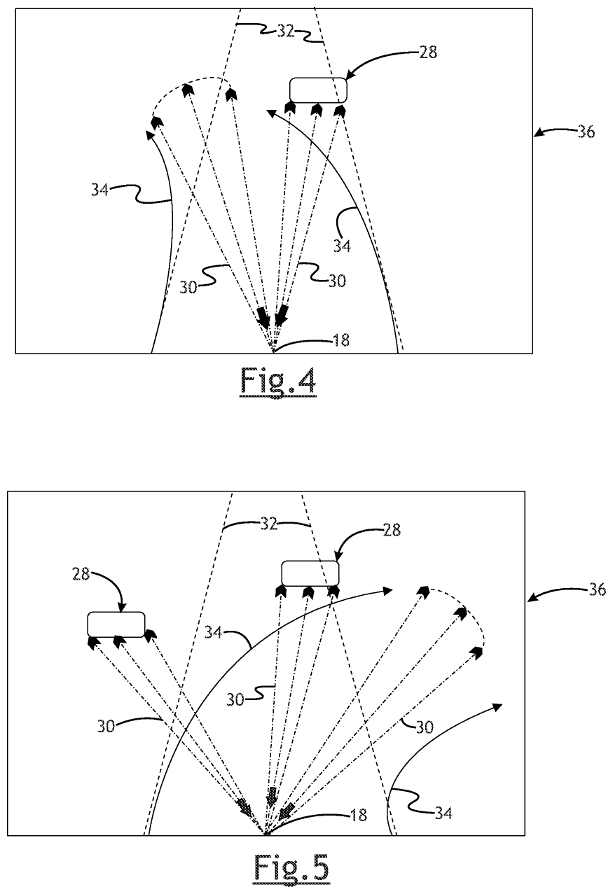

For example, in FIG. 2, the controller 26, via one or more underwater sensors 18, has detected an obstacle 28, such as a rock, ahead of the vehicle 12 and of a certain size. The information about the detected obstacle 28 can be compared to one or more predetermined parameters to determine if the vehicle 12 can be driven over the detected obstacle 28. If not, a different path of travel for the vehicle 12 should be chosen or the vehicle 12 should be removed from the water 14 (e.g. operated in reverse). In FIG. 4, an initial or current travel path 32 for the vehicle 12 is shown in dashed lines on the vehicle display screen 36, and the detected obstacle 28 is within the current travel path 32, and is beyond one or more predetermined thresholds (for example, the obstacle 28 has too great of a height). The data from the underwater sensors 18 indicates that the area to the left of the detected obstacle 28 is passable (in this example that area is devoid of obstacles 28), and so a new travel path 34 is determined by the controller 26 and is indicated in solid lines. In FIG. 5, two obstacles 28 are detected, with one in the current travel path 32 and one to the left of the current travel path 32. Here, the underwater sensor data indicates that an area to the right of both obstacles 28 is passable, and so a corresponding new travel path 34 is determined, and is indicated in solid lines.

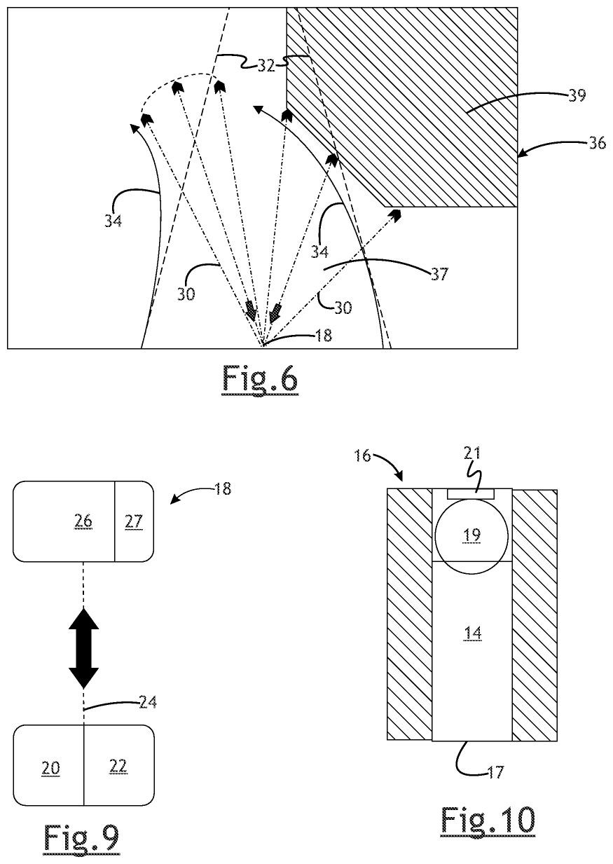

Next, as shown in FIG. 3, the underwater sensors 18 may be used to detect a first area 37 adjacent to the vehicle 12 that has a first water depth 38 that is less than a water depth threshold), and a second area 39 farther from the vehicle 12 that has a second water depth 40 that is greater than the water depth threshold. In this situation, the controller 26 may determine a path of travel that includes the first area but not the second area. In this regard, in FIG. 6, a current travel path 32 is shown in dashed lines and intersects the second area 39 in which the water 14 is too deep. Here, the underwater sensor data indicates that an area to the left of the second area 39 is passable, so the controller 26 determines a corresponding new travel path 34 through the first area 37 but moving left of the second area 39 and proceeding in areas having a water depth less than the threshold water depth. If there are no travel paths that do not contain an underwater environmental parameter that is not beyond a corresponding threshold, the new vehicle path 34 may require stopping the vehicle 12 and reversing in the direction the vehicle 12 came from, to remove the vehicle 12 from the water 14.

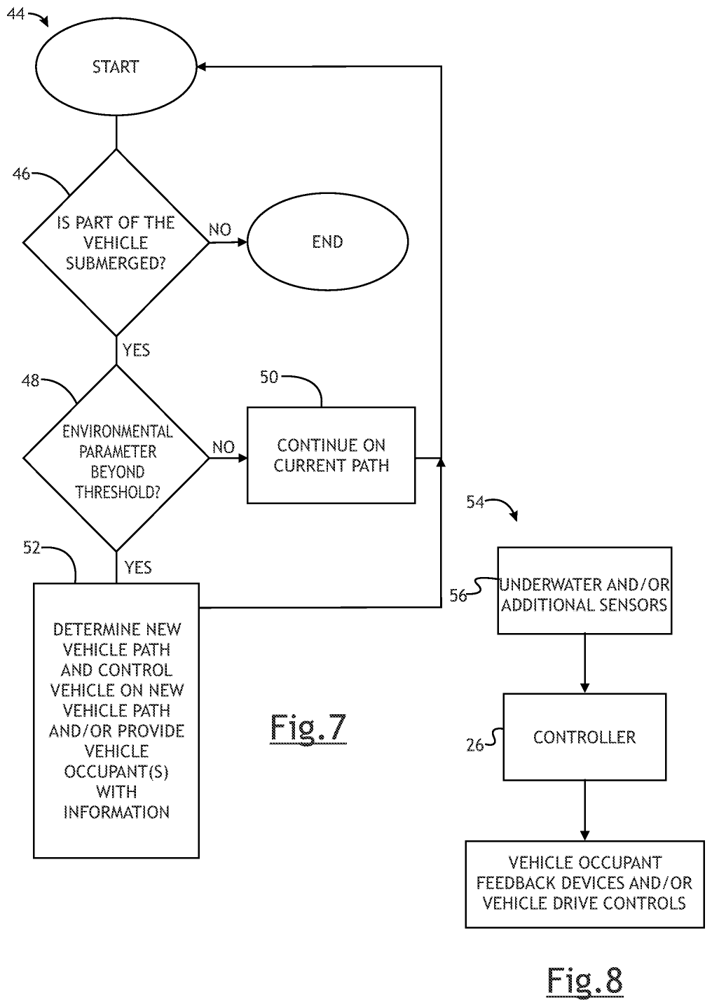

Once a new vehicle travel path 34 is determined, either the new vehicle path 34 is communicated to the vehicle occupant(s) (e.g. on a display screen 36) or the vehicle drive controls are operated by the vehicle control system (which may include or be defined by the controller 26) such that the vehicle 12 leaves the current vehicle path of travel 32 and follows the new vehicle path of travel 34. A method 44 of determining a new vehicle path of travel 34 is shown in FIG. 7. First, in step 46 it is determined, e.g. via the submersion sensor 16, of at least part of the vehicle 12 is submerged in water 14. Next, in step 48 the current vehicle path 32 is checked for underwater environmental parameters beyond a threshold, such as obstacles 28 or water depth 14 that are greater than a predetermined threshold. If the current vehicle path 32 is free of parameters beyond a threshold, then the vehicle 12 can, as shown in step 50, continue on the current path 32 and no change needs to be made to the already determined, current path of travel 32. If the current vehicle path of travel 32 contains one or more underwater environmental parameters beyond a threshold, then a new vehicle path of travel 34 is generated in step 52 of FIG. 7 that avoids the underwater environmental parameters that are beyond a threshold.

In the method of FIG. 7, the vehicle 12 may be controlled, such as by the vehicle control system, utilizing the new vehicle path of travel 34, or the information regarding the new travel path 34 may be communicated to the driver for use by the driver. In the first example, the vehicle control system may alter one or more vehicle parameters such as vehicle speed, vehicle direction, wheels driven, braking, and/or power application. Additionally, the vehicle occupant(s) may be provided with feedback regarding information about the new vehicle path 34, such a data or graphics on a visual display screen 36, by audible signal or by tactile feedback (e.g. vibrations in certain areas of the vehicle 12 to guide a driver). The information provided to the vehicle occupant(s) may consist of not only the path of travel, but information regarding various underwater environmental parameters, like one or more of a depth of the water 14 at one or more positions, a velocity of the water 14 and a direction of flow of the water 14, and may include a video feed from one or more vehicle 12 mounted cameras. While the above methods are described with regard to finding paths of travel that do not include underwater environmental parameters beyond a threshold, the system 10 may also be used to determine an improved path of travel that is better in at least one underwater environmental parameter than the current path of travel 32. For example, an improved path of travel might have less depth of water 14 than the current path of travel 32 and may be selected even though the water depth in the current path of travel 32 is less than the corresponding threshold and so a new path of travel 34 is not necessary, but may be preferred. Such an analysis may be done with respect to any or all other underwater environmental parameters as well, to determine an easier or otherwise improved path of travel for the vehicle 12. In this way, the system 10 can ensure that the vehicle 12 does not travel through an area of a body of water 14 that has one or more underwater environmental parameters beyond a threshold, and the system 10 may determine one or more improved paths of travel through the body of water, as the vehicle 12 travels through the body of water 14.

In implementations that determine improved paths of travel even when the current path of travel 32 is acceptable, the determination may be continually made as the vehicle 12 moves through new areas of the body of water 14 along the current path of travel 32. That is, the sensors may determine underwater environmental parameters for a limited area of the body of water 14 and so new data from the sensors is used as the vehicle 12 moves, to provide information about areas to be navigated by the vehicle 12. Thus, the system 10 may continually review information from the sensors as the vehicle 12 travels through the body of water 14.

It should be understood that water 14 in this application is construed to include liquids primarily comprising of H2O. Often land vehicles 12 are driven through water 14 in an outdoor environment. In these environments, water 14 is commonly contaminated with foreign substances such as biological material, chemicals, or other matter. It should be appreciated that water 14 in this disclosure is intended to encompass both water, the liquid itself, and water with the presence of foreign contaminants as may be experienced by land vehicles 12.

What is claimed is:

1. An underwater detection system for a land vehicle, comprising:
a submersion sensor adapted to determine when at least part of a vehicle is submerged in water;
an underwater sensor capable of detecting an underwater environmental parameter; and
a controller coupled to both the submersion sensor and the underwater sensor.

2. The system of claim 1, comprising a display to show a vehicle occupant: a) a determined vehicle path of travel, b) data or graphics derived from data obtained from the submersion sensor or the underwater sensor, c) or both a and b.

3. The system of claim 1, comprising a fluid flow sensor, a vehicle speed sensor, or a vehicle inclination sensor.

4. The system of claim 1, wherein the underwater sensor provides output to the controller as a function of the location and size of objects and water depth surrounding the vehicle.

5. The system of claim 4, including a display, wherein feedback including the location and size of objects and water depth surrounding the vehicle is displayed to a vehicle occupant.

6. The system of claim 4, wherein feedback is provided to the controller and the controller is adapted to communicate with a driving control system that uses the feedback to navigate the vehicle.

7. The system of claim 1, which also comprises a global positioning system coupled to the controller.

8. The system of claim 1, which also comprises a vehicle drive control system capable of changing vehicle drive controls.

9. A method of navigating a land vehicle through water, comprising the steps of:
determining that at least part of the vehicle is submerged in water;
receiving information from an underwater sensor; and
either or both a) controlling the vehicle as a function of the information, or b) providing feedback as a function of the information to a driver of the vehicle.

10. The method of claim 9, wherein one or more of a vehicle speed and a vehicle direction is controlled as a function of the information from the underwater sensor.

11. The method of claim 9, wherein providing feedback as a function of the information to a driver of the vehicle is accomplished by providing a visual display that is viewable by the driver.

12. The method of claim 9, wherein the information includes one or more of a depth of the water at one or more locations, a velocity of the water and a direction of flow of the water.

13. The method of claim 12, wherein the vehicle has a current path of travel, and wherein the depth of water in the current path of travel is compared to the depth of water outside the current path of travel.

14. The method of claim 13, wherein the vehicle is controlled to change the path of travel when the depth of water outside the current path of travel is less than the depth of water in the current path of travel.

15. The method of claim 9, wherein controlling the vehicle as a function of the information includes one or more of controlling acceleration, braking, and steering or direction of the vehicle.

16. The method of claim 9, wherein the information is used to detect that an obstacle is within a path of travel of the vehicle.

17. The method of claim 9, wherein the information is used to detect an obstacle outside of a path of travel of the vehicle.

18. The method of claim 16, wherein controlling the vehicle as a function of the information includes altering one or both of vehicle speed and vehicle direction as a function of the detection of the obstacle.
